(19) United States
(12) Patent Application Publication
(10) Pub. No.: US 2018/0293495 A1
(43) Pub. Date: Oct. 11, 2018

(54) COMPUTER SYSTEM AND COMPUTATION METHOD USING RECURRENT NEURAL NETWORK

(71) Applicant: Hitachi, Ltd., Tokyo (JP)

(72) Inventors: Tadashi OKUMURA, Tokyo (JP); Mitsuharu TAl, Tokyo (JP); Hiromasa TAKAHASHI, Tokyo (JP); Masahiko ANDO, Tokyo (JP); Norifumi KAMESHIRO, Tokyo (JP); Sanato NAGATA, Tokyo (JP)

(21) Appl. No.: 15/900,826

(22) Filed: Feb. 21, 2018

(30) Foreign Application Priority Data
Apr. 5, 2017 (JP) 2017-075587

(51) Int. Cl. G06N 3/08; G06F 17/30; G06N 3/04; G06F 17/18

(52) U.S. Cl. CPC G06N 3/08; G06F 17/18; G06N 3/04; G06F 17/30551

(57) ABSTRACT

A computer system that executes computation processing using a recurrent neural network constituted with an input unit, a reservoir unit, and an output unit. The input unit includes an input node that receives a plurality of time-series data, the reservoir unit includes a nonlinear node accompanying time delay, the output unit includes an output node calculating an output value. The input unit calculates a plurality of input streams by executing sample and hold processing and mask processing on a plurality of received time-series data, executes time shift processing that gives deviation in time to each of the plurality of input streams and superimposes the plurality of input streams subjected to the time shift processing, thereby calculating input data.

### CLAIM OF PRIORITY

The present application claims priority from Japanese patent application JP 2017-075587 filed on Apr. 5, 2017, the content of which is hereby incorporated by reference into this application.

### BACKGROUND OF THE INVENTION

### Field of the Invention

The present invention relates to reservoir computing.

### Background Art

In recent years, a neural network that imitates a cranial nerve network has been used in machine learning. The neural network is constituted with an input layer, an output layer, and a hidden layer. In the hidden layer, it is possible to obtain a desired output such as identification and prediction of information by repeating simple transformation and transforming input data to high dimensional data.

As an example of transformation of the hidden layer, there is nonlinear transformation imitating firing phenomenon of a neuron. The firing phenomenon of neuron is known as a nonlinear phenomenon in which a membrane potential rapidly rises and output varies in a case where a potential exceeding a threshold value is input to the neuron. In order to reproduce the phenomenon described above, for example, a sigmoid function expressed by the equation (1) is used.

$$f ( x ) = \frac{1}{1 + exp ( - x )}$$

A neural network used for recognizing an image and the like is called a feedforward network. In the feedforward network, an independent data group at a certain time is handled as input and data is sent in the order of the input layer, the hidden layer, and the output layer.

A neural network used for identifying a moving image and a language is called a recurrent neural network. In order to identify time-varying data, analysis including correlation of data on a time axis is required and thus, time-series data is input. For that reason, in the hidden layer of the recurrent neural network, processing which handles past data and current data is executed.

The recurrent neural network has a problem that a learning processing becomes complicated as compared with the feedforward network. There is also a problem that calculation cost of the learning processing is high. For that reason, in general, the number of neurons in the recurrent neural network is set to be small.

As a scheme for solving the problem described above, a method called reservoir computing is known (see, for example, Japanese Patent Application No. 2002-535074 and JP-A-2004-249812). In the reservoir computing, connection of a network constituting a reservoir corresponding to the hidden layer is fixed and learning is performed on connection between a reservoir and the output layer.

The reservoir constituted with one nonlinear node and one delay loop accompanying time delay has been proposed as reservoir computing that can be implemented in a computer (for example, L. Larger, M. C. Soriano, D. Brunner, L. Appeltant, J. M. Gutierrez, L. Pesquera, C. R. Mirasso, and I. Fischer, Optics Express, 20, 2012, p. 3241). In L. Larger, M. C. Soriano, D. Brunner, L. Appeltant, J. M. Gutierrez, L. Pesquera, C. R. Mirasso, and I. Fischer, Optics Express, 20, 2012, p. 3241, matters that a delay interval is equally divided into N and each point is regarded as a virtual node to thereby construct a network of reservoirs are described. The reservoir described in L. Larger, M. C. Soriano, D. Brunner, L. Appeltant, J. M. Gutierrez, L. Pesquera, C. R. Mirasso, and I. Fischer, Optics Express, 20, 2012, p. 32411 is simple in configuration and can be easily installed on a computer.

Here, with reference to FIG. 9, reservoir computing including the reservoir described in L. Larger, M. C. Soriano, D. Brunner, L. Appeltant, J. M. Gutierrez, L. Pesquera, C. R. Mirasso, and I. Fischer, Optics Express, 20, 2012, p. 3241 is described.

Data input to the input layer is subjected to sample and hold processing. In flattening processing, sampling is performed for each section of a width T. Here, T corresponds to a delay time. Furthermore, mask processing which divides one section into N sub-sections and modulates data input to the input layer is executed for the data. An input signal on which processing described above is executed is processed for each width T. N values included in the width T are handled as states of the virtual nodes.

Regardless of whether data input to the input layer is continuous time data or discrete time data, the data is transformed into discretized data. In the reservoir, the total sum of values obtained by multiplying a weight and the state of each virtual node is output to the output layer.

In a case of the reservoir computing described in L. Larger, M. C. Soriano, D. Brunner, L. Appeltant, J. M. Gutierrez, L. Pesquera, C. R. Mirasso, and I. Fischer, Optics Express, 20, 2012, p. 3241, one nonlinear node constituting the reservoir functions as an input port for data transmitted from the input layer. For that reason, the number of series of data input is limited to the number of input ports.

In a case of complicated processing using different input data, the reservoir described in L. Larger, M. C. Soriano, D. Brunner, L. Appeltant, J. M. Gutierrez, L. Pesquera, C. R. Mirasso, and I. Fischer, Optics Express, 20, 2012, p. 3241 cannot handle a plurality of input data items at once. As the complicated processing, there is, for example, processing described in Jordi Fonollosa, Sadique Sheik, Ramón Huerta, and Santiago Marcob, Sensors and Actuators B: Chemical, 215, 2015, p. 618. In Jordi Fonollosa, Sadique Sheik, Ramón Huerta, and Santiago Marcob, Sensors and Actuators B: Chemical, 215, 2015, p. 618, processing for identifying a component of a mixed gas is described. Specifically, processing for outputting a concentration of each gas in the mixed gas, in which two types of gases are mixed, using data output from sixteen sensors is described.

As a method for implementing the processing described above using the reservoir computing in L. Larger, M. C. Soriano, D. Brunner, L. Appeltant, J. M. Gutierrez, L. Pesquera, C. R. Mirasso, and I. Fischer, Optics Express, 20, 2012, p. 3241, methods illustrated in FIGS. 10A, 10B, and 10C are conceivable.

FIG. 10A illustrates a parallel method. In the parallel method, an input layer and the reservoir are parallelized in accordance with the number of types of input data. In a case of the parallel method, an installation scale increases and thus, there is a problem that an apparatus becomes larger in size.

FIG. 10B illustrates a serial method. In the serial method, a memory for temporarily storing data is provided at the input side and the output side of the reservoir. An apparatus sequentially processes the input data.

When processing is completed for input data 1, the apparatus stores a processing result in the memories of the output side and the input side. In a case where processing on input data 2 is executed, the apparatus executes processing using the processing result of the input data 1 stored in the input side memory and the input data 2. Hereinafter, similar processing is executed.

In this method, a processing time is lengthened in proportion to the number of input data and thus, high-speed processing cannot be implemented. A memory for storing the processing results before and after is required and thus, there is also a problem that the apparatus becomes larger in size.

FIG. 10C illustrates another serial method. In the serial method, the number of virtual nodes is increased in accordance with the number of input data and a plurality of input data items are alternately input to the reservoir. A distance between the virtual nodes depends on a switching speed.

In a case of the serial method, a size of a delay network, that is, a delay time becomes long and thus, a processing speed is lowered. Also, in a case of installing the reservoir using an optical circuit, a length of an optical waveguide becomes long and thus, there is a problem that an apparatus becomes larger in size. In the case of installing the reservoir using an electronic circuit, it is necessary to increase a memory capacity for holding a value of each input data.

In the present specification, the case of describing the parallel method indicates the method of FIG. 10A. The case of describing the serial method indicates the method of FIG. 10B or FIG. 10C.

### SUMMARY OF THE INVENTION

An object of the present invention is to provide a system and a method capable of implementing reservoir computing without increasing an apparatus scale and capable of processing a plurality of time-series data with high accuracy and high speed.

A representative example of the invention disclosed in the present application is as follows. That is, there is provided a computer system that executes computation processing using a neural network including an input unit, a reservoir unit, and an output unit and includes at least one computer. The at least one computer includes a computation device and a memory connected to the computation device. The input unit includes an input node that receives a plurality of time-series data, the reservoir unit includes a nonlinear node that receives data output by the input unit and has time delay, and the output unit includes an output node that receives an output from the reservoir unit and calculates an output value. The input unit receives a plurality of time-series data, divides each of the plurality of time-series data by a first time width, calculates a first input stream for each of the plurality of time-series data by executing sample and hold processing on the time-series data included in the first time width, calculates a plurality of second input streams for the plurality of first input streams by executing mask processing that modulates the first input stream with a second time width, executes time shift processing that gives time shift on each of the plurality of second input streams, calculates a third input stream by superimposing the plurality of second input streams subjected to the time shift processing, and inputs the third input stream to the nonlinear node.

According to the present invention, it is possible to implement reservoir computing without increasing an apparatus scale and process a plurality of time-series data with high accuracy and at a high speed. The problems, configurations, and effects other than those described above will be clarified by description of the following examples.

### BRIEF DESCRIPTION OF THE DRAWINGS

FIG. 1 is a diagram illustrating a configuration example of a computer that implements reservoir computing according to Example 1.

FIG. 2 is a diagram illustrating a concept of the reservoir computing according to Example 1.

FIG. 3 is a flowchart for explaining processing executed by an input unit according to Example 1.

FIG. 4A is a diagram illustrating a concept of processing executed by the input unit according to Example 1.

FIG. 4B is another diagram illustrating the concept of processing executed by the input unit according to Example 1.

FIG. 4C is another diagram illustrating the concept of processing executed by the input unit according to Example 1.

FIG. 4D is another diagram illustrating the concept of processing executed by the input unit according to Example 1.

FIG. 4E is another diagram illustrating the concept of processing executed by the input unit according to Example 1.

FIG. 4F is another diagram illustrating the concept of processing executed by the input unit according to Example 1.

FIG. 5A is a diagram illustrating an example of time-series data input to the computer according to Example 1.

FIG. 5B is a graph illustrating output results of a parallel method of the related art.

FIG. 5C is a graph illustrating output results of a reservoir unit according to Example 1.

FIG. 6 is a diagram illustrating performance of a method according to Example 1.

FIG. 7A is a diagram illustrating an example of a configuration of a computer according to Example 2.

FIG. 7B is a diagram illustrating another example of the configuration of the computer according to Example 2.

FIG. 8 is a diagram illustrating an example of a configuration of an optical circuit chip according to Example 3.

FIG. 9 is a diagram illustrating a logical structure of reservoir computing of the related art.

FIG. 10A is a diagram illustrating a solution to a problem to be solved in the reservoir computing of the related art.

FIG. 10B is another diagram illustrating the solution to the problem to be solved in the reservoir computing of the related art.

FIG. 10C is another diagram illustrating the solution to the problem to be solved in the reservoir computing of the related art.

### DETAILED DESCRIPTION OF THE INVENTION

Hereinafter, an embodiment of the present invention will be described with reference to the drawings. In all drawings for explaining the embodiment, the same reference numerals are given to portions having the same function, and redundant description thereof will be omitted. The drawings indicated in the following merely illustrate examples of the embodiment, and sizes of the drawings do not always match scales described in the examples.

### Example 1

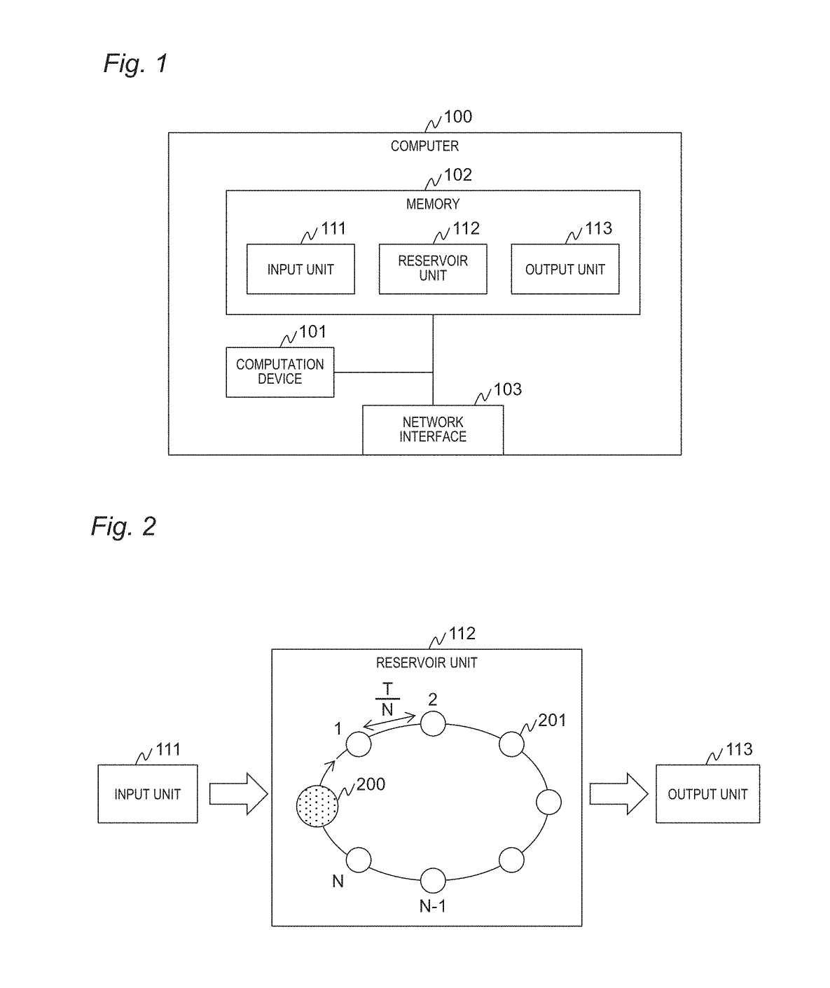

FIG. 1 is a diagram illustrating a configuration example of a computer 100 that implements reservoir computing according to Example 1.

The computer 100 includes a computation device 101, a memory 102, and a network interface 103.

The computation device 101 executes processing according to a program. As the computation device 101, a processor, a field programmable gate array (FPGA), or the like can be considered. The computation device 101 executes processing according to the program to implement a predetermined functional unit. In the following description, when processing is described by using a functional unit as a subject, the description indicates that the computation device 101 executes a program that implements the functional unit.

The memory 102 stores a program executed by the computation device 101 and information used by the program. The memory 102 includes a work area temporarily used by the program.

The network interface 103 is an interface for connecting to an external apparatus such as a sensor via a network.

The computer 100 may include an input/output interface connected to an input device such as a keyboard and a mouse and an output device such as a display.

The memory 102 according to Example 1 stores a program implementing an input unit 111, a reservoir unit 112, and an output unit 113 that implement a recurrent neural network.

The input unit 111 executes processing corresponding to an input layer of the reservoir computing. The reservoir unit 112 executes processing corresponding to a reservoir of the reservoir computing. The output unit 113 executes processing corresponding to an output layer of the reservoir computing.

FIG. 2 is a diagram illustrating a concept of the reservoir computing according to Example 1.

The input unit 111 includes an input node that receives a plurality of time-series data. The input unit 111 executes data transformation processing to generate input data x(t) from the plurality of time-series data and output the input data x(t) to the reservoir unit 112.

The reservoir unit 112 is constituted with one nonlinear node 200 accompanying time delay. The reservoir unit 112 may include two or more nonlinear nodes 200. When the input data x(t) is received from the input unit 111, the nonlinear node 200 divides the input data x(t) into pieces of data each of which consists of a piece of data with a time width T and executes computation processing by using the divided piece of data with the time width T as one processing unit.

Here, T represents a delay time (length of a delay network). The divided input data x(t) is handled as an N-dimensional vector. N represents the number of virtual nodes.

In the computation processing, the reservoir unit 112 executes nonlinear transformation illustrated in the data equation (2) to calculate N-dimensional data q(t). Each component of the data q(t) is expressed by the equation (3).

q(t)=f(x(t)+cq(t−T)) (2)

q(t)=(q(t),q(t+τ_{M}),q(t+2τ_{M}), . . . ,q(t+(N−1)τ_{M})) (3)

Here, the c in the equation (2) represents a recurrence coefficient. The function f is a nonlinear function and is given by, for example, the equation (4).

$$f ( t ) = \frac{1}{1 + exp \{ - a ( r - b ) \}} \qquad ( 4 )$$

Here, coefficients a and b are adjustable parameters. In the equation (2), two terms within the parenthesis of the function f represent a delayed signal.

The present invention is not limited to a mathematical expression used in nonlinear transformation processing. For example, nonlinear transformation processing using an arbitrary trigonometric function or the like may be used.

The data q(t) is transmitted to a delay network constituted with virtual nodes 201. Specifically, a value of each component of the equation (3) is emulated as a state value of the virtual node 201. In the following description, the value of each component of the equation (3) is described as qᵢ(t). The subscript i is a value from 1 to N.

Data y(t) output from the delay network is input to the delay network again as illustrated in the equation (2). With this, superimposition of different pieces of data can be implemented.

The output unit 113 includes an output node that receives data input from the reservoir unit 112. A result of the computation processing as illustrated in the equation (5) is input from the reservoir unit 112.

y(t)=Σᵢ₌₁^{N}wᵢqᵢ(t) (5)

Here, wᵢ represents a weight coefficient. The data y(t) is a scalar value.

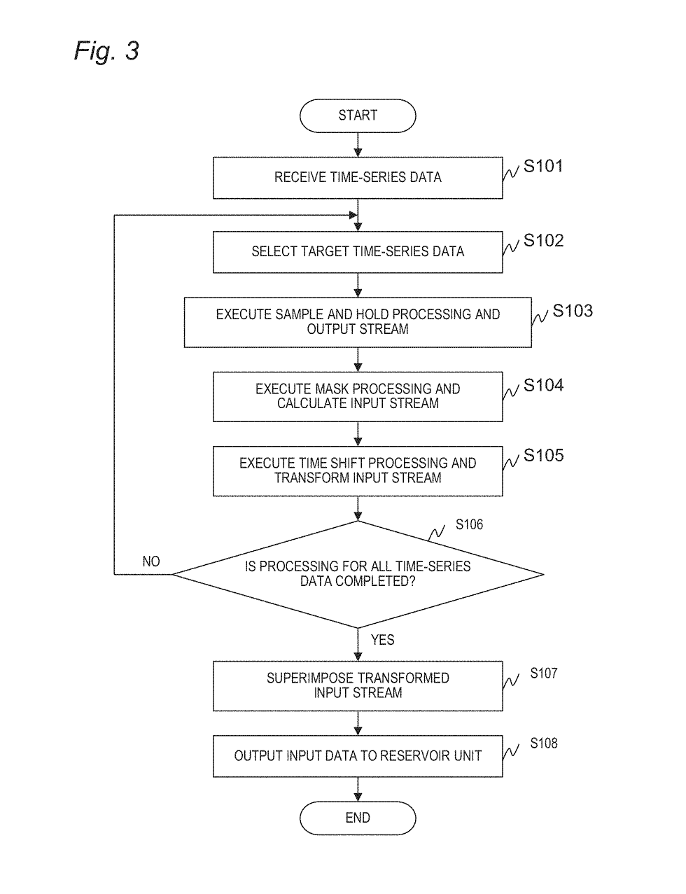

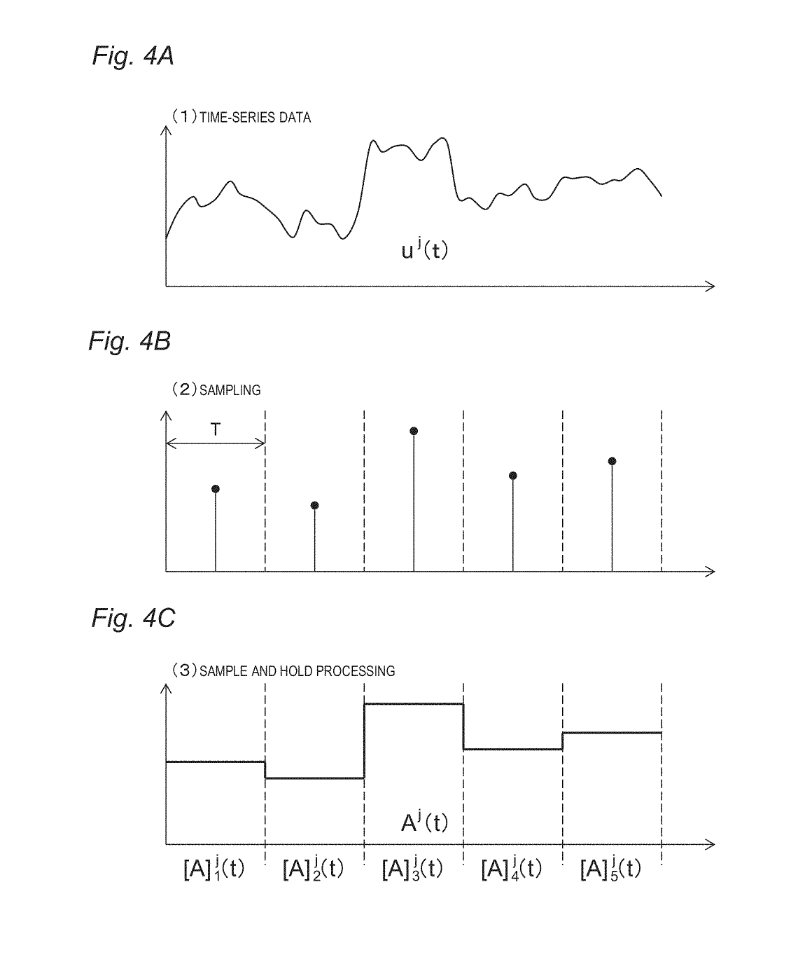

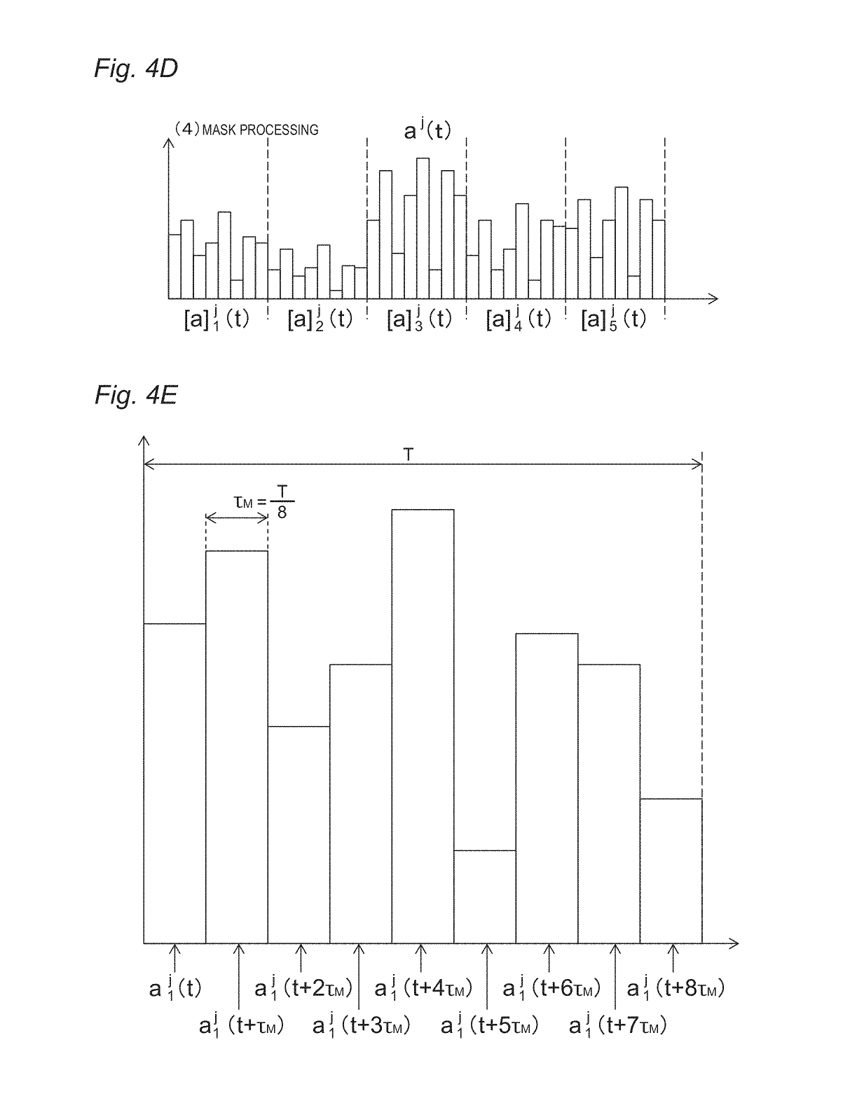

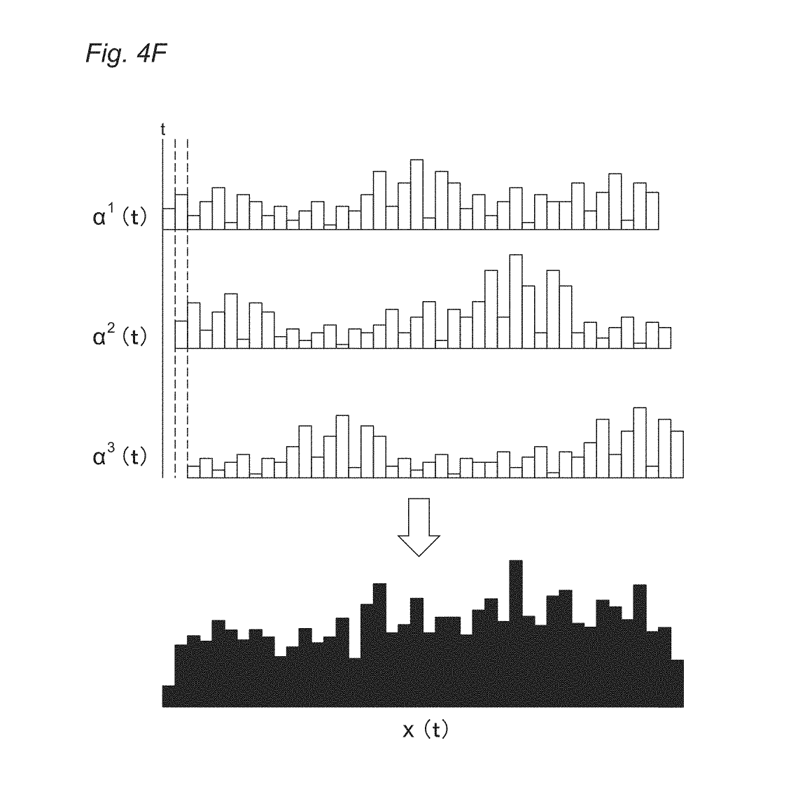

Specific processing executed by the input unit 111 will be described. FIG. 3 is a flowchart illustrating processing executed by the input unit 111 according to Example 1. FIG. 4A, FIG. 4B, FIG. 4C, FIG. 4D, FIG. 4E, and FIG. 4F are diagrams illustrating the concept of processing executed by the input unit 111 according to Example 1.

The input unit 111 receives a plurality of time-series data u^{j}(t) (step S101). In this case, the input unit 111 initializes a counter value m to 0. Here, the subscript j is a value for identifying time-series data. For example, the input unit 111 receives the time-series data u^{j}(t) illustrated in FIG. 4A.

Next, the input unit 111 selects target time-series data u^{j}(t) from the pieces of time-series data (step S102). In this case, the input unit 111 adds 1 to the counter value m.

Next, the input unit 111 executes sample and hold processing on the target time-series data u^{j}(t) to calculate a stream A^{j}(t) (step S103). A sampling period is T. Sampling as illustrated in FIG. 4B is performed for the time-series data u^{j}(t) illustrated in FIG. 4A and the sample and hold processing is further executed so as to obtain the stream A^{j}(t) as illustrated in FIG. 4C.

In the following description, the stream A^{j}(t) in one section is described as a stream [A]^{j}ₖ(t). As illustrated in FIG. 4C, the stream [A]^{j}ₖ(t) has a constant value in one section.

Next, the input unit 111 executes mask processing for modulating intensity for each stream [A]^{j}ₖ(t) every time width τ_{M} to calculate an input stream a^{j}(t) (step S104). For example, the input stream a^{j}(t) as illustrated in FIG. 4D is obtained. In Example 1, intensity modulation is performed in the range from −1 to +1. Here, τ_{M} represents a distance between the virtual nodes and satisfies the equation (6).

T=N×τ_{M} (6)

The modulation may be either amplitude modulation or phase modulation. Specific modulation is performed by multiplying the stream A^{j}(t) by a random bit sequence.

The random bit sequence may be a binary random bit sequence and may be a discrete multi-level random bit sequence such as an 8-level or a 16-level. Further, the random bit sequence may be a signal sequence illustrating continuous intensity change. In a case of modulation using the binary random bit sequence, there is an advantage that a system configuration can be simplified and can be implemented by using existing devices. In a case of modulation using the multi-level random bit sequence, there is an advantage that complicated dynamics can be reproduced and thus, calculation accuracy is improved.

In the following description, the input stream a^{j}(t) of one section is denoted by an input stream [a]^{j}ₖ(t). The input stream [a]^{j}ₖ(t) is an N-dimensional vector and is expressed by the following equation (7). In FIG. 4E, details of the input stream [a]^{j}ₖ(t) are illustrated.

[a]ₖ^{j}(t)=(aₖ^{j}(t),aₖ^{j}(t+τ_{M}),aₖ^{j}(t+2τ_{M}), . . . ,aₖ^{j}(t+(N−1)τ_{M})) (7)

Next, the input unit 111 executes time shift processing of generating deviation in time based on the counter value m to transform the input stream a^{j}(t) into an input stream α^{j}(t) (step S105). Thereafter, the input unit 111 proceeds to step S107.

The time shift processing may be processing of delaying the time or processing of advancing the time. For example, time shift processing represented by the equation (8) is performed.

a^{j}(t)→α^{j}(t)=a^{j}(t+(m−1)τ_{M}) (8)

The equation (8) is time shift processing that gives a delay to another input stream a^{j}(t) by using an arbitrary input stream a^{j}(t) as a reference. As illustrated in the equation (8), an input stream of which the counter value m is “1” is used becomes the reference.

A method of generating delay is not limited to the method described above. For example, delay may be generated every integer times τ_{M}. Also, the delay may be randomly generated irrespective of the counter value m.

An input stream α^{P}(t) of which the counter value m is p is delayed by pτ_{M} from an input stream α¹(t). The delay is sufficiently smaller than the time T in a case where N is large.

Next, the input unit 111 determines whether processing is completed for all time-series data or not (step S106).

In a case where it is determined that processing is not completed for all time-series data, the input unit 111 returns to step S102 and executes similar processing.

In a case where it is determined that processing is completed for all time-series data, the input unit 111 calculates the input data x(t) by superimposing each input stream αⱼ(t) (step S107). Superimposition of the input stream α^{j}(t) is defined by, for example, the equation (9). By the processing, the input data x(t) as illustrated in FIG. 4F is obtained.

x(t)−Σⱼα^{j}(t) (9)

Next, the input unit 111 inputs the input data x(t) to the nonlinear node 200 of the reservoir unit 112 (step S108). Thereafter, the input unit 111 ends processing.

As another processing method, the following method may be considered. After processing of step S104 is completed, the input unit 111 temporarily stores the input stream a^{j}(t) in the work area of the memory 102 and thereafter, executes processing of step S106. In a case where the determination result of step S106 is YES, read timing of each input stream a^{j}(t) is adjusted and superimposed. The read timing is adjusted so as to make it possible to give deviation in time.

As described above, the input unit 111 according to Example 1 inputs the input data x(t), which is obtained by superimposing a plurality of delayed time-series data, to the nonlinear node 200 of the reservoir unit 112.

Next, a specific example using the reservoir computing according to Example 1 will be described. Here, processing described in Jordi Fonollosa, Sadique Sheik, Ramón Huerta, and Santiago Marcob, Sensors and Actuators B: Chemical, 215, 2015, p. 618 is used as a model. In Jordi Fonollosa, Sadique Sheik, Ramón Huerta, and Santiago Marcob, Sensors and Actuators B: Chemical, 215, 2015, p. 618, processing of receiving a plurality of pieces of input information relating to a mixed gas and outputting concentrations of gas X and gas Y in the mixed gas is described.

In this identification processing, time-series data input from sixteen gas sensors is handled. That is, the subscript j of the time-series data u^{j}(t) has a value from 1 to 16. In this case, the target time-series data u^{j}(t) is transformed into the input stream α^{j}(t).

In order to avoid an increase in a signal intensity of input data to be input to the delay network, the input data was adjusted in advance such that the input data is output to the reservoir unit 112 after the intensity of the input data is attenuated to 5%.

For teaching data y′(t) relating to the gas X, learning of the weight coefficient wᵢ was performed so that the value of the equation (10) is minimized. A set value of a gas flow rate controller is used as the teaching data. The subscript 1 represents the number of output data y(t).

Σ₁(Σᵢ₌₁^{N}wᵢqᵢ(t)−y′(t)) (10)

In Example 1, the weight coefficient wᵢ was determined using a least square method. Specifically, the weight coefficient wᵢ was calculated from a linear equation with N unknowns of the equation (11).

$$\begin{matrix}\frac{\partial }{\partial {w}_{1}} Σ ( {\sum }_{i = 1}^{N} {w}_{i} {q}_{i} ( t ) - {y}^{′} ( t ) ) {x}_{k} ( t ) = 0 \\ \frac{\partial }{\partial {w}_{2}} Σ ( {\sum }_{i = 1}^{N} {w}_{i} {q}_{i} ( t ) - {y}^{′} ( t ) ) {x}_{k} ( t ) = 0 \\ \\ \frac{\partial }{\partial {w}_{N}} Σ ( {\sum }_{i = 1}^{N} {w}_{i} {q}_{i} ( t ) - {y}^{′} ( t ) ) {x}_{k} ( t ) = 0\end{matrix} \qquad ( 11 )$$

Similar learning was also performed for teaching data z′(t) relating to the gas Y.

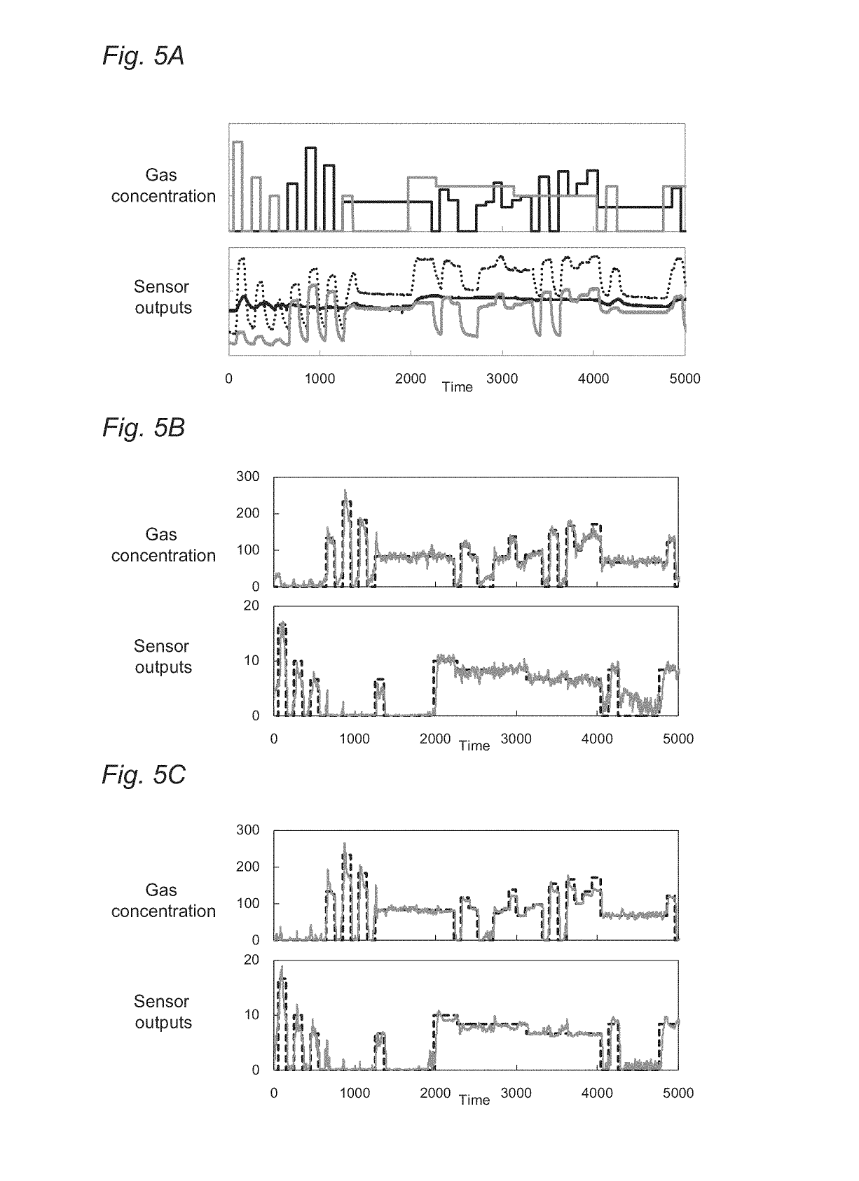

FIG. 5A is a diagram illustrating an example of time-series data input to the computer 100 according to Example 1. The upper graph of FIG. 5A illustrates a setting value of a gas flow meter and the lower graph illustrates an output value from one sensor. The black solid line illustrates a value of the gas X and the gray solid line illustrates a value of the gas Y.

FIG. 5B is a graph illustrating output results of a parallel method of the related art. The upper graph in FIG. 5B illustrates an output relating to the gas X and the lower graph illustrates an output relating to the gas Y.

FIG. 5C is a graph illustrating output results of the reservoir unit 112 according to Example 1.

The black dashed lines in FIGS. 5B and 5C correspond to the set values of the gas flow meter and represent teaching data. The solid lines in FIGS. 5B and 5C are estimated values of gas concentrations calculated using the values output from the 16 sensors.

As illustrated in FIG. 5B and FIG. 5C, it is possible to obtain highly accurate results similarly as in the parallel method of the related art, in the method according to Example 1.

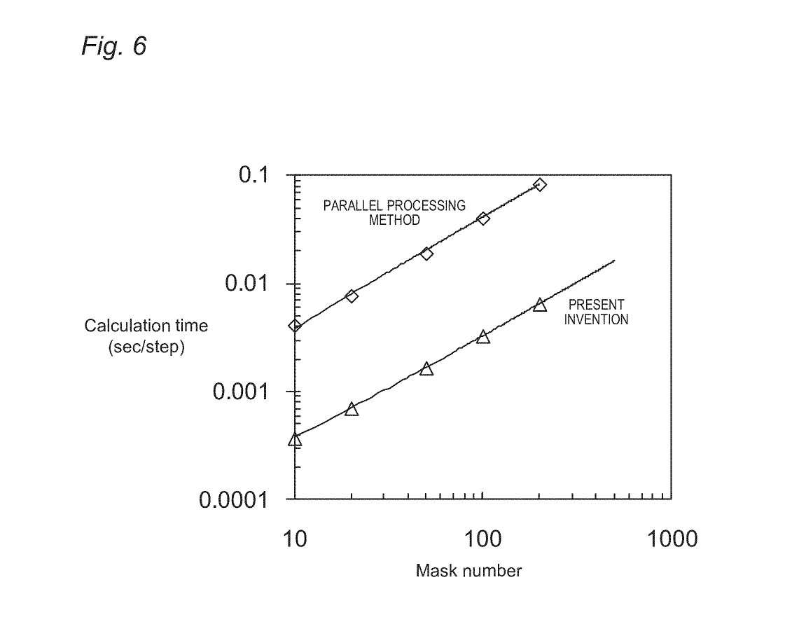

FIG. 6 is a diagram illustrating performance of the method according to Example 1.

Here, a performance difference between the method according to Example 1 and the parallel method of the related art is illustrated as an example. A performance difference test was conducted using a commercially available desktop type personal computer. The horizontal axis illustrates the number of divisions of the period T, that is, the number of virtual nodes. The vertical axis illustrates a calculation speed per one point in time-series data.

As illustrated in FIG. 6, the number of virtual nodes in the method according to Example 1 is smaller than that of the method of the related art. That is, matters that the calculation amount can be reduced are illustrated. Accordingly, matters that the calculation speed was improved by one digit or more compared with the method of the related art were confirmed.

In the reservoir computing according to Example 1, calculation costs can be reduced with high accuracy and at high speed. The reservoir unit 112 is a reservoir unit of the related art and thus, it is possible to prevent the apparatus scale from becoming large.

### Example 2

In Example 1, the input unit 111, the reservoir unit 112, and the output unit 113 are implemented as software, but in Example 2, these units are implemented by using hardware. In the following, details according to Example 2 will be described.

The nonlinear node 200 of the reservoir unit 112 can be implemented by using hardware such as an electronic circuit and an optical element. As the electronic circuit, it is possible to use a Macky-Glass circuit and the source-drain current of the MOSFET. As the optical element, an MZ interferometer and an optical waveguide exhibiting nonlinear characteristics such as saturation absorption can be used.

In Example 2, a computer that implements the reservoir unit 112 using the optical waveguide will be described.

An optical device has network characteristics such as high speed performance of communication and low propagation loss in the optical waveguide and thus, it is expected that the optical device is utilized for processing which is performed at high speed and of which power consumption is suppressed.

In a case where reservoir computing is implemented using the optical waveguide, a Mach-Zehnder interferometer type optical modulator (MZ-modulator) or a laser is used as the nonlinear node 200. For that reason, in a case where a plurality of delay networks are constructed to process a plurality of time-series data, there is a problem to be solved that the apparatus scale becomes large.

In a case where processing is executed sequentially using a plurality of time-series data using one delay network, processing delay can be suppressed, but a capacity of the memory for temporarily storing data is increased and thus, there is a problem to be solved that the apparatus scale becomes large.

In Example 2, the problem to be solved described above is solved by installing the input unit 111 according to Example 1 as hardware.

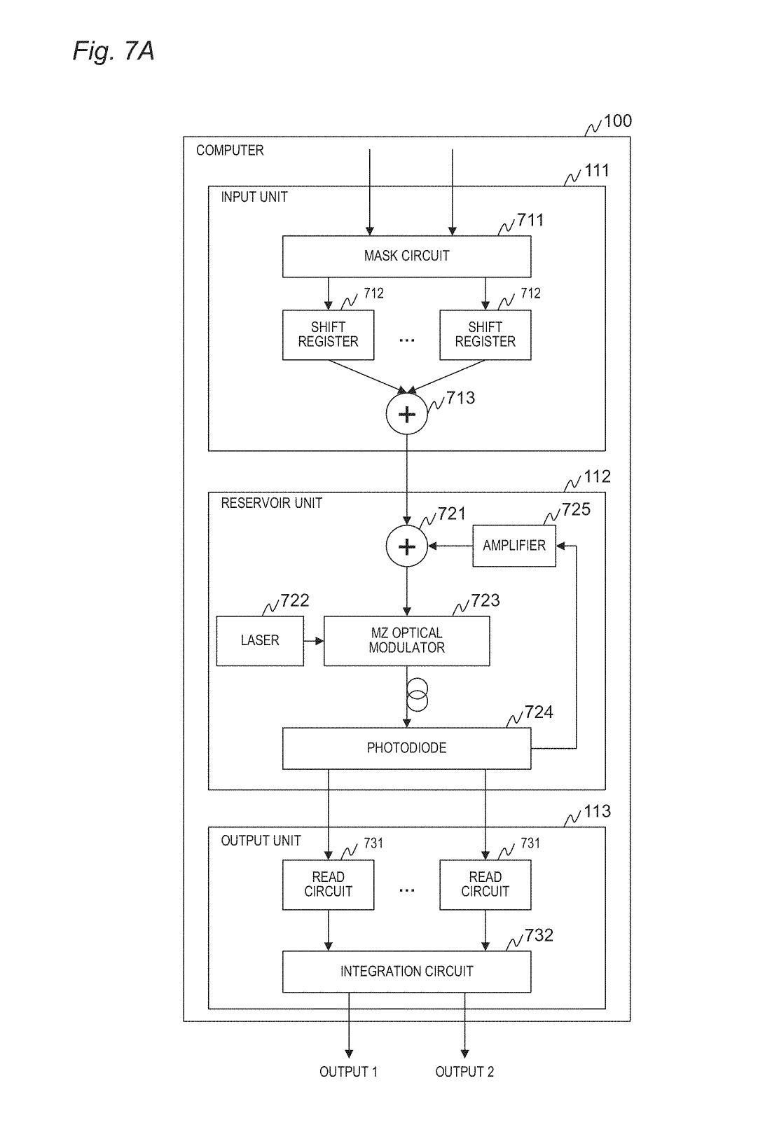

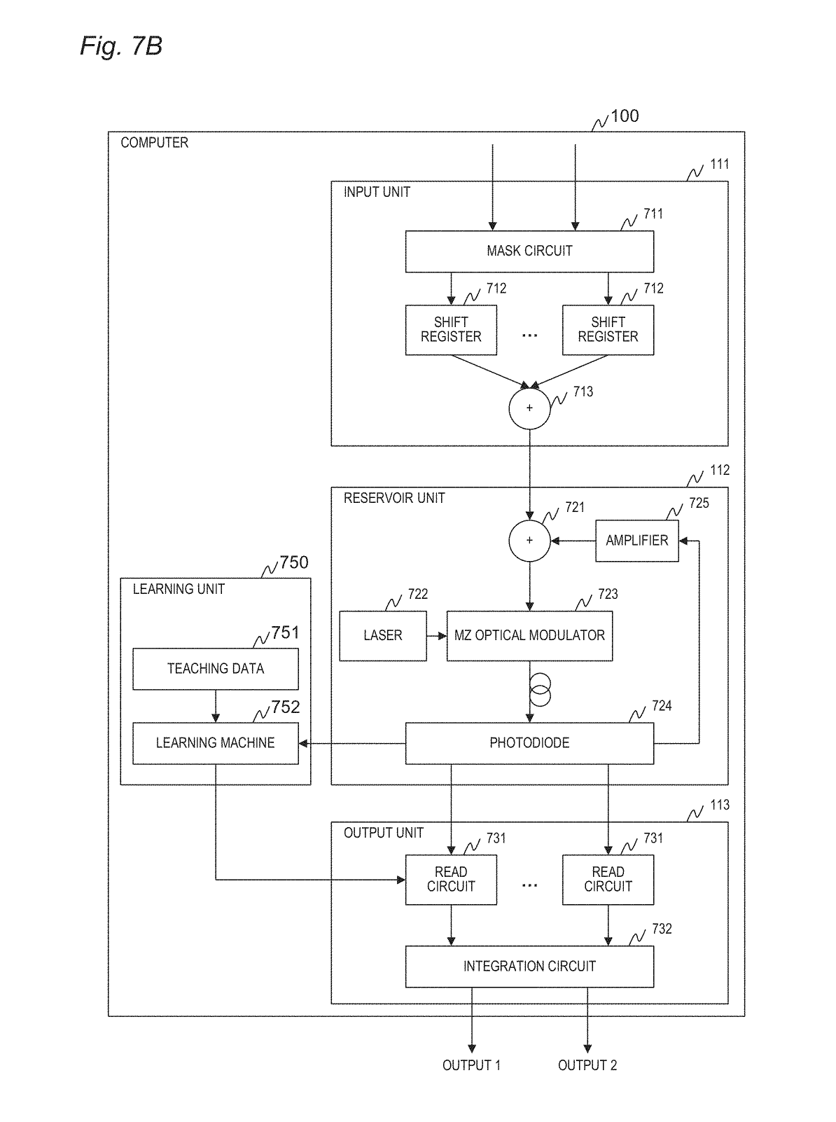

FIGS. 7A and 7B are diagrams illustrating an example of a configuration of the computer 100 according to Example 2. In Example 2, parameters are illustrated as an example for identifying the concentration of the mixed gas.

The computer 100 according to Example 2 receives time-series data from sixteen gas sensors. A sampling frequency of the gas sensor that inputs time-series data is 100 Hz and a restart frequency of the delay network is 10 kHz. Accordingly, the processing speed in the delay network is sufficiently faster than the sampling rate of the gas sensor.

In Example 2, the period T of the delay network is 100 microseconds and the number of virtual nodes is 100. Accordingly, the reservoir unit 112 operates at 1 MHz.

First, the configuration of the computer 100 in FIG. 7A will be described.

The input unit 111 includes a mask circuit 711, a plurality of shift registers 712, and a computation unit 713.

The mask circuit 711 executes computation processing corresponding to processing of steps S103 and S104 for each input time-series data. The mask circuit 711 outputs the input stream a^{j}(t) obtained by processing one piece of time-series data to one shift register 712.

The shift register 712 executes computation processing corresponding to processing of step S105 for the input stream a^{j}(t). The shift register 712 outputs the calculated input stream α^{j}(t) to the computation unit 713. In Example 2, a delay circuit for generating delay in the input stream a^{j}(t) using the shift register 712 is implemented. However, the delay circuit may be a delay circuit constituted with a ladder type transmission circuit network constituted with a capacitor and an inductor.

The computation unit 713 executes computation processing corresponding to processing of step S107 using the input stream αⱼ(t) input from each shift register 712. The computation unit 713 outputs a computation result to the reservoir unit 112.

The reservoir unit 112 includes a computation unit 721, a laser 722, an MZ optical modulator 723, a photodiode 724, and an amplifier 725. The MZ optical modulator 723 and the photodiode 724 are connected via an optical fiber.

The computation unit 721 executes computation processing expressed by the equation (2). That is, the computation unit 721 superimposes the input data x(t) input from the input unit 111 and the data q(t) output from the reservoir unit 112. The computation unit 721 outputs the computation result as a signal to the MZ optical modulator 723.

The laser 722 inputs laser light of arbitrary intensity to the MZ optical modulator 723. The laser 722 according to Example 2 emits laser light having a wavelength of 1310 nm.

The MZ optical modulator 723 is hardware for implementing the nonlinear node 200. In Example 2, a fiber coupled LN (LiNbO₃)-MZ modulator was used. The MZ optical modulator 723 modulates intensity of laser light input from the laser 722 using the signal input from the computation unit 721. Light transmission characteristic of the MZ optical modulator 723 corresponds to a square of a sine wave with respect to an input electric signal and thus, an amplitude is nonlinearly transformed.

In Example 2, the input electric signal is adjusted from a signal of 0.4 V to a signal of 1 V.

The length of the optical fiber to be connected between the MZ optical modulator 723 and the photodiode 724 is a length required for a predetermined time to transmit laser light output from the MZ optical modulator 723. The time required for transmission of laser light is a period of the delay network. In Example 2, the MZ optical modulator 723 and the photodiode 724 are connected by using an optical fiber having a length of 20 km. Accordingly, it takes 100 microseconds to transmit the signal.

The photodiode 724 transforms input laser light into an electric signal and, further divides the electric signal into branches, outputs one electric signal to the output unit 113, and outputs another electric signal to the amplifier 725.

The amplifier 725 amplifies or attenuates the signal input from the photodiode 724, and then outputs the signal to the computation unit 721.

The output unit 113 includes a plurality of read circuits 731 and an integration circuit 732.

The read circuit 731 reads the signal output from the reservoir unit 112. The read circuit 731 operates so as to be synchronized with the mask circuit 711. An operation speed of the read circuit 731 varies at an amplification factor of 1 MHz and the read circuit 731 operates at a cycle of 10 kHz. The amplification factor is determined by learning processing. The read circuit 731 outputs the read signal to the integration circuit 731.

The integration circuit 732 integrates the signal at a predetermined time and outputs a processing result. The integration circuit 732 according to Example 2 integrates signal intensities every 100 microseconds.

Next, the configuration of FIG. 7B will be described. The configurations of the input unit 111, the reservoir unit 112, and the output unit 113 of the computer 100 of FIG. 7B are the same as the configurations of those units of the computer 100 of FIG. 7A. However, the photodiode 724 of FIG. 7B is different from that of FIG. 7A in that the photodiode 724 of FIG. 7B outputs an electric signal to a learning machine 752.

A learning unit 750 includes teaching data 751 and the learning machine 752. The teaching data 751 is data used for the learning processing. The learning machine 752 executes the learning processing for determining the weight coefficient for connecting the virtual node 201 and the node of the output layer by using the teaching data 751 and the electric signal input from the photodiode 724. In the learning processing, in a case where it is necessary to compare the result of the computation processing which is output by the output unit 113 with the teaching data 751, the output unit 113 outputs the result of the computation processing to the learning machine 752.

According to Example 2, it is possible to implement high speed reservoir computing having reduced power consumption. The apparatus scale can be suppressed. The existing reservoir unit 112 and output unit 113 can be used and thus, the cost for installing can be reduced.

### Example 3

In Example 3, the computer 100 in which the reservoir computing according to Example 1 is implemented using an optical circuit chip will be described.

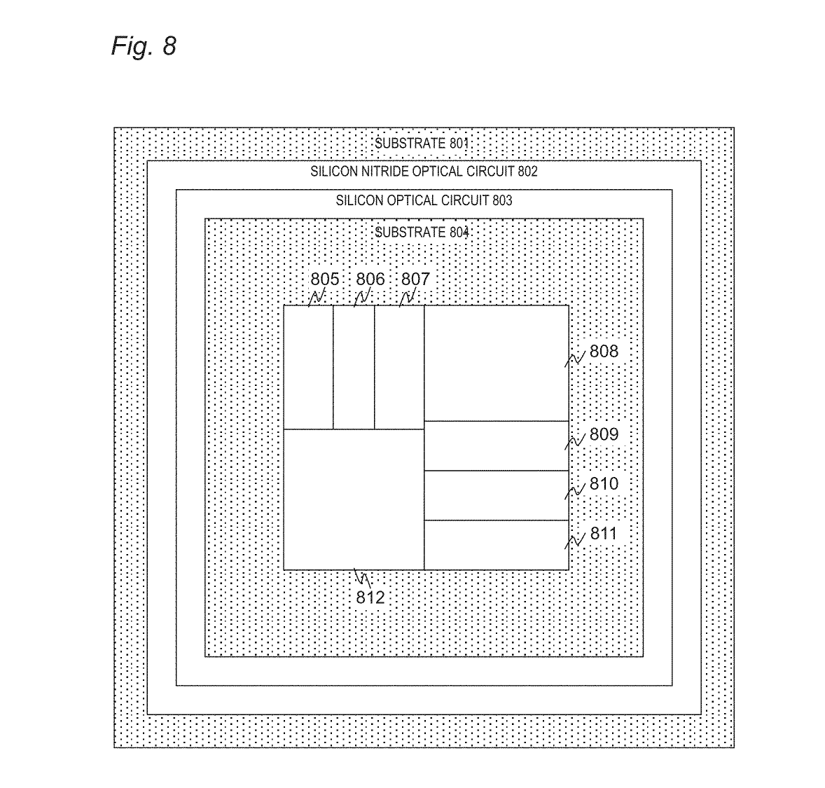

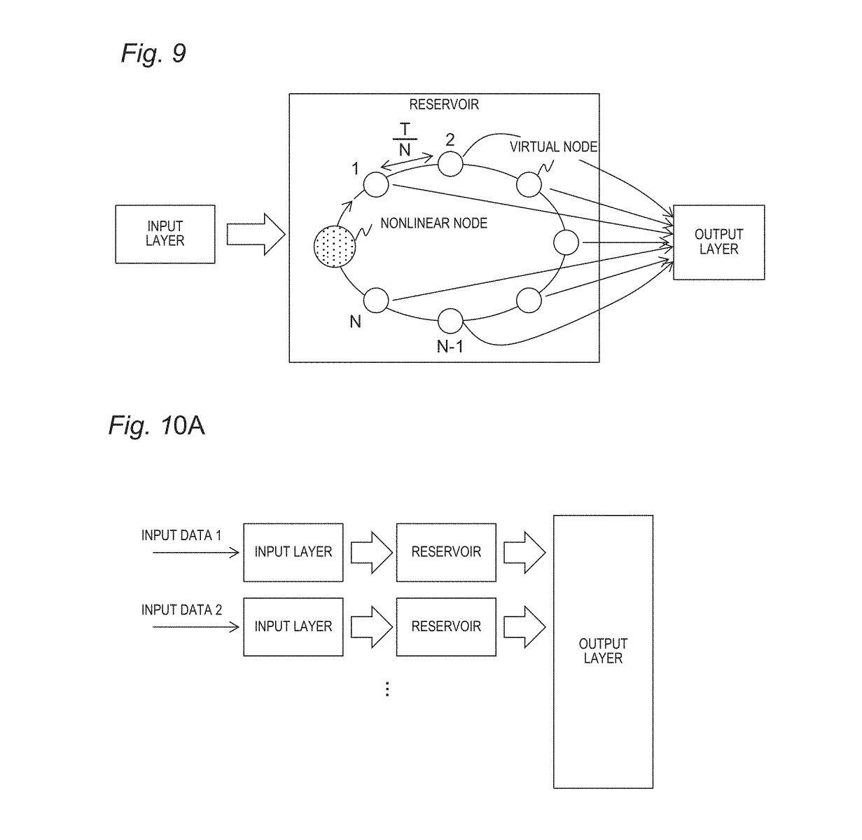

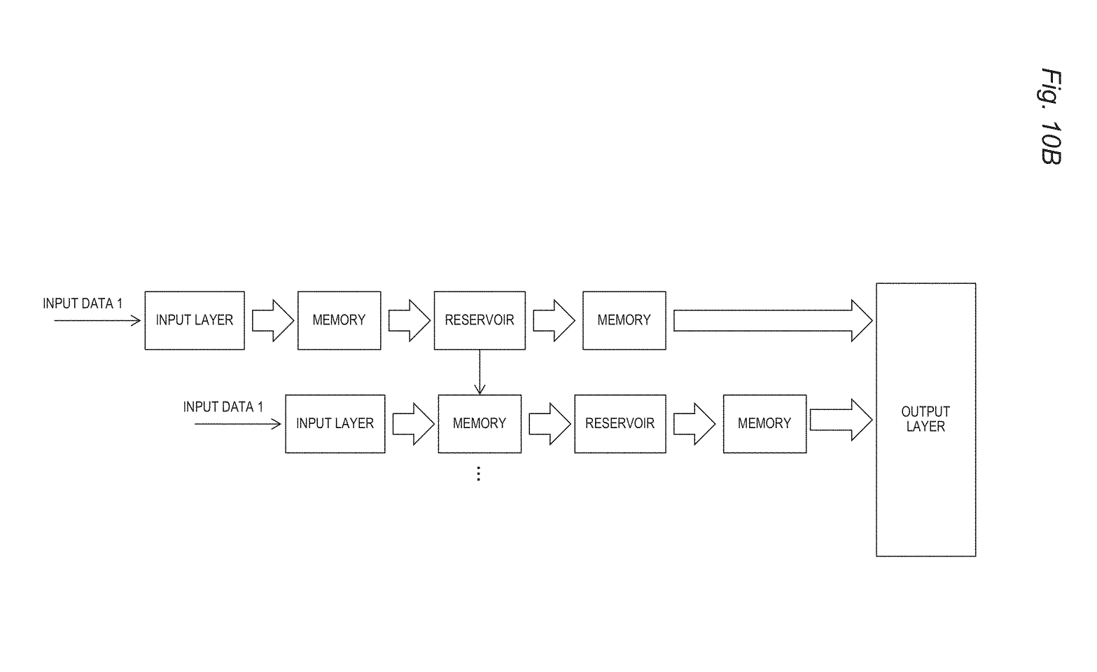

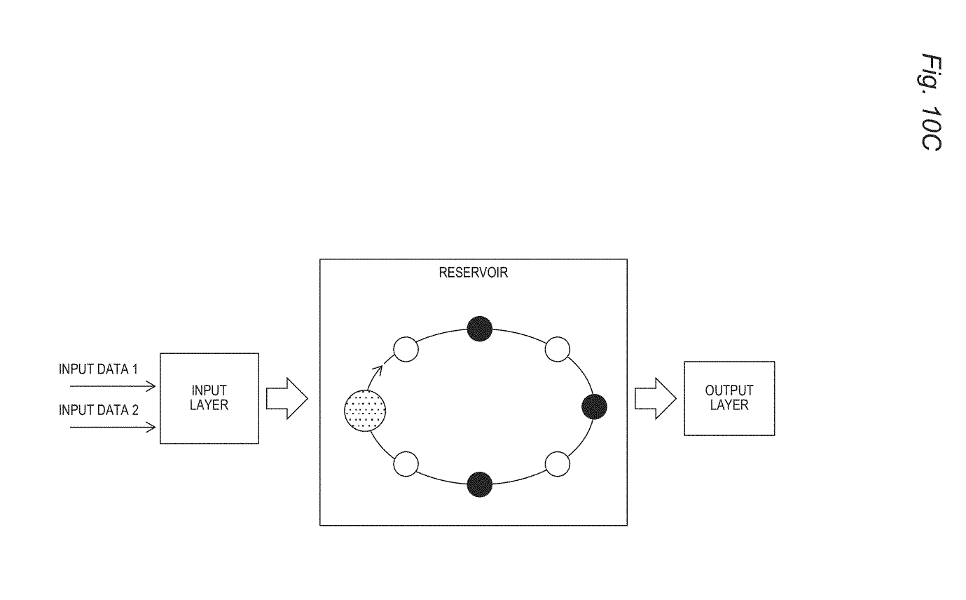

FIG. 8 is a diagram illustrating an example of a configuration of the optical circuit chip according to Example 3. FIG. 8 corresponds to a top view of the optical circuit chip.

In an optical circuit chip 800, a plurality of function chips are mounted on a substrate 801. An optical circuit is mounted in a stacking direction with respect to the electronic circuit and thus, optical elements such as an MZ modulator and a photodiode do not appear in the drawing.

The optical circuit chip 800 includes the substrate 801, a silicon nitride optical circuit 802, a silicon optical circuit 803, a substrate 804, a sampling circuit 805, a mask circuit 806, a delay circuit 807, a modulator drive circuit 808, a recurrent signal amplifier 809, a transimpedance amplifier 810, a read circuit 811, and an integration circuit 812.

The sampling circuit 805, the mask circuit 806, the delay circuit 807, the modulator drive circuit 808, the recurrent signal amplifier 809, the transimpedance amplifier 810, the read circuit 811, and the integration circuit 812 are integrated on the same chip.

In Example 3, the period of the delay network is set to 10 nanoseconds and thus, the silicon nitride optical circuit 802 which uses silicon nitride as a waveguide layer is used. In order to secure a delay time of 10 nanoseconds, an optical waveguide having a length of approximately 1.5 meters is needed.

The silicon waveguide including the MZ modulator is formed in the silicon optical circuit 803 and the waveguide of silicon nitride for delay is formed in the silicon nitride optical circuit 802. Optical coupling can be ensured by inputting and outputting light in the direction of a substrate surface from each other by using diffraction or a mirror. On a portion of the silicon optical circuit 803 including the MZ modulator, a silicon nitride region may be formed and a silicon nitride waveguide for a delay may be provided.

The MZ modulator has a band of 40 GHz and has performance to follow the signal output from the mask circuit 806 operating at 10 GHz. The photodiode may be flip-chip mounted on the silicon optical circuit 803 or may be mounted as a Ge photodiode integrated in the silicon optical circuit 803. The photodiode transforms the optical signal input from the MZ modulator into an electric signal and outputs the electric signal to the transimpedance amplifier 810 and the read circuit 811.

The sampling circuit 805, the mask circuit 806, and the delay circuit 807 are circuits constituting the input unit 111.

The sampling circuit 805 is a circuit that executes sampling and hold processing on time-series data. The mask circuit 806 is a circuit that executes mask processing. The delay circuit 807 is a circuit for generating a delay in the input stream a^{j}(t) output from the mask circuit 806. The mask circuit 806 operates at 10 GHz.

The silicon nitride optical circuit 802, the silicon optical circuit 803, the modulator drive circuit 808, the recurrent signal amplifier 809, and the transimpedance amplifier 810 are circuits constituting the reservoir unit 112.

The chip of the semiconductor laser that emits laser light is flip-chip mounted on the silicon optical circuit 803 and is able to supply continuous light to the silicon waveguide of the optical integrated circuit.

The modulator drive circuit 808 is a circuit for driving the MZ modulator.

The transimpedance amplifier 810 amplifies the signal output by the photodiode and outputs the amplified signal to the recurrent signal amplifier 809 and the read circuit 811.

The recurrent signal amplifier 809 inputs the signal input from the transimpedance amplifier 810 to the MZ modulator via a wiring.

The read circuit 811 reads a signal from the transimpedance amplifier 810 and outputs the signal to the integration circuit 812.

The integration circuit 812 executes an integral computation on the input signal and outputs the computation result.

Each circuit of the optical circuit chip 800 is designed in such a way that the sum of the delay times of the wiring and the optical waveguide coincides with the period of the delay network.

According to Example 3, the optical circuit chip is used so as to make it possible to implement the reservoir computing of the present invention in a small robot such as a drone, an unmanned aerial vehicle, or a micro air vehicle.

The present invention is not limited to the examples described above, but includes various modification examples. For example, the examples described above are examples in which configurations are described in detail in order to explain the present invention in an easily understandable manner, and are not necessarily limited to examples having all configurations described above. Further, a portion of the configuration of each example can be added to, deleted from, or replaced with other configurations.

In addition, each of the configurations, functions, processing units, processing means, and the like described above may be implemented in hardware by designing some or all of those, for example, by an integrated circuit. Also, the present invention can be implemented by a program code of software which implements the functions of the examples. In this case, a non-transitory storage medium having stored the program code is provided in a computer and a processor provided in the computer reads the program code stored in the non-transitory storage medium. In this case, the program code itself read from the non-transitory storage medium implements the functions of the examples described above and the program code itself and the non-transitory storage medium having stored the program code constitute the present invention. As a storage medium for supplying such a program code, for example, a flexible disk, a CD-ROM, a DVD-ROM, a hard disk, a solid state drive (SSD), an optical disk, a magneto-optical disk, a CD-R, a magnetic disk, a non-volatile memory card, a ROM, or the like is used.

A program code for implementing the functions described in the examples can be implemented in a wide range of programs or script languages such as an assembler, C/C++, perl, Shell, PHP, and Java (registered trademark).

Furthermore, the program code of software implementing the functions of the examples is delivered via a network so that the program code may be stored in a storing unit such as a hard disk or a memory of a computer or a storage medium such as a CD-RW, or a CD-R and the processor provided in the computer may read and execute the program code stored in the storing unit or the storage medium.

Furthermore, in the examples described above, control lines and information lines, which are considered necessary for explanation, are illustrated and those lines do not necessarily illustrate all of control lines and information lines needed for a product. All configurations may be connected to each other.

What is claimed is:

1. A computer system that executes computation processing using a recurrent neural network including an input unit, a reservoir unit, and an output unit, the computer system comprising:
at least one computer,
wherein the at least one computer includes a computation device and a memory connected to the computation device,
the input unit includes an input node that receives a plurality of time-series data,
the reservoir unit includes at least one nonlinear node that receives input data output by the input unit and has time delay,
the output unit includes an output node that receives an output from the reservoir unit, and
the input unit
receives a plurality of time-series data,
divides each of the plurality of time-series data by a first time width,
calculates a first input stream for each of the plurality of time-series data by executing sample and hold processing on the time-series data included in the first time width,
calculates a plurality of second input streams for each of the plurality of the first input streams by executing mask processing that modulates the first input stream with a second time width,
executes time shift processing that gives time shift on each of the plurality of second input streams, and
calculates the input data by superimposing the plurality of second input streams subjected to the time shift processing.

2. The computer system according to claim 1,
wherein different magnitudes of delay are given to the plurality of first input streams.

3. The computer system according to claim 2,
wherein the input unit includes
a mask circuit that calculates the first input stream and the second input stream,
a plurality of shift registers that give the time shift to each of the plurality of second input streams, and
a computation circuit that superimposes the plurality of second input streams subjected to the time shift processing.

4. The computer system according to claim 2,
wherein in the time shift processing,
the input unit temporarily stores the plurality of second input streams in the memory, and
the input unit adjusts read timing and reads each of the plurality of second input streams from the memory.

5. A computation method using a recurrent neural network in a computer system including at least one computer, the at least one computer including a computation device and a memory connected to the computation device, the recurrent neural network including an input unit, a reservoir unit, and an output unit, the input unit including an input node that receives a plurality of time-series data, the reservoir unit including at least one nonlinear node that receives input data output by the input unit and has time delay, the output unit including an output node that receives an output from the reservoir unit, the computation method comprising:
causing the input unit to receive a plurality of time-series data;
causing the input unit to divide each of the plurality of time-series data by a first time width;
causing the input unit to execute sample and hold processing on the time-series data included in the first time width and thus to calculate a first input stream for each of the plurality of time-series data;
causing the input unit to execute mask processing that modulates the first input stream with a second time width and thus to calculate a plurality of second input streams for each of the plurality of first input streams;
causing the input unit to execute time shift processing that gives time shift on each of the plurality of second input streams, and
causing the input unit to calculate the input data by superimposing the plurality of second input streams subjected to the time shift processing.

6. The computation method using a recurrent neural network according to claim 5,
wherein different magnitudes of delay are given to the plurality of first input streams.

7. The computation method using a recurrent neural network according to claim 6,
wherein the input unit includes
a mask circuit that calculates the first input stream and the second input stream,
a plurality of shift registers that give the time shift to each of the plurality of second input streams, and
a computation circuit that superimposes the plurality of second input streams subjected to the time shift processing.

8. The computation method using a recurrent neural network according to claim 6,
wherein causing the input unit to execute time shift processing includes
causing the input unit to temporarily store the plurality of second input streams in the memory, and
causing the input unit to adjust read timing and to read each of the plurality of second input streams from the memory.
